(19) United States
(12) Patent Application Publication
(10) Pub. No.: US 2018/0167723 A1
(43) Pub. Date: Jun. 14, 2018

(54) MICROPHONE

(71) Applicants: Kai WANG, Shenzhen (CN); Hu CHEN, Shenzhen (CN)

(72) Inventors: Kai WANG, Shenzhen (CN); Hu CHEN, Shenzhen (CN)

(73) Assignee: AAC Acoustic Technologies (Shenzhen) Co., Ltd., Shenzhen (SZ)

(21) Appl. No.: 15/415,975

(22) Filed: Jan. 26, 2017

(30) Foreign Application Priority Data
Dec. 10, 2016 (CN) 201621352860.2
Dec. 10, 2016 (CN) 201621352884.8

(51) Int. Cl. H04R 1/28; H04R 1/04; H04R 1/08

(52) U.S. Cl. CPC H04R 1/2876; H04R 1/086; H04R 1/04

(57) ABSTRACT

A microphone is provided in the present disclosure. The microphone includes a protective shell, wherein the protective shell includes a housing and a circuit board connected with the housing by covering to form a receiving cavity, and the housing is provided with a first sound hole communicated with the receiving cavity; in the receiving cavity, the microphone further comprises a control circuit chip and a micro electromechanical chip with a back cavity which are disposed on the circuit board, and the circuit board is provided with a second sound hole communicated with the back cavity; the microphone further comprises a controller disposed at the first sound hole; the controller has a first operating position and a second operating position, and the first sound hole connects the external space of the protective shell with the receiving cavity at the first operating position, and the controller disconnects the external space of the protective shell from the receiving cavity at the second operating position,

### FIELD OF THE DISCLOSURE

The present invention relates to the technical field of electronic devices, and specifically, relates to a microphone.

### BACKGROUND

The traditional microphones, which are divided into multiple categories and have simple functions, include omnidirectional microphones and unidirectional microphones. The omnidirectional microphones have substantially same sensitivity to sound in all directions around, so the pickup range of the omnidirectional microphones is relatively wide, but the omnidirectional microphones have the problem of high noise. The pickup range of the unidirectional microphones is directional; that is to say, the unidirectional microphones are smaller in pickup range but lower in noise. The unidirectional microphones and the omnidirectional microphones are respectively used sometimes in many occasions according to different needs, and two microphones are often disposed in one device at the moment to realize a magnetic function, so that the production cost is increased and more space is occupied at the same time.

Therefore, it is desired to provide a microphone to overcome the aforesaid problems.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of embodiment 1 of a microphone of the present invention; and

FIG. 2 is a structural schematic diagram of embodiment 2 of a microphone of the present invention.

### DETAILED DESCRIPTION

The present disclosure will be described in detail below with reference to the attached drawings and embodiments thereof.

### Embodiment 1

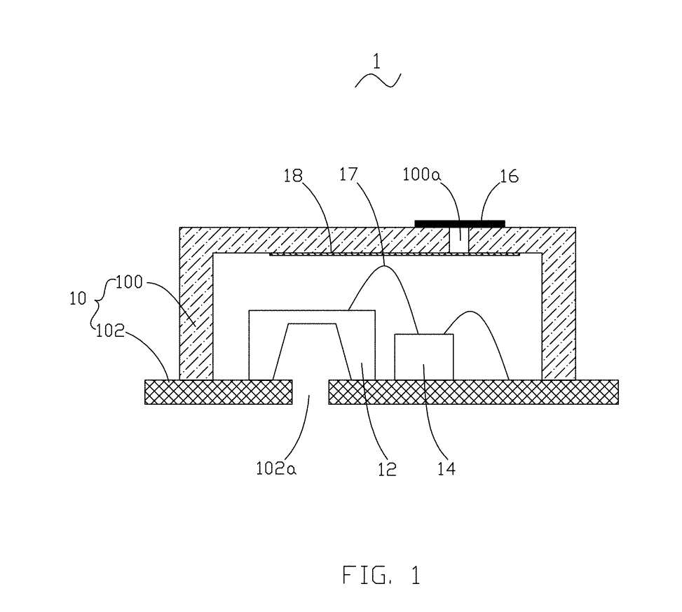

As shown in FIG. 1, a microphone 1 includes a protective shell 10, a micro electromechanical chip 12 with a back cavity, a control circuit chip 14, a controller 16 and a connecting wire 17.

The protective shell 10 includes a housing 100 and a circuit board 102 connected with the housing 100 by covering to form a receiving cavity. The micro electromechanical chip 12 and the control circuit chip 14 are received in the receiving cavity, and specifically, can be disposed on the circuit board 102 and electrically connected to the circuit board 102 by the connecting wire 17. The housing 100 is provided with a first sound hole 100a communicated with the receiving cavity in the housing 100, and the circuit board 102 is provided with a second sound hole 102a communicated with the back cavity of the micro electromechanical chip 12.

The controller 16 is disposed on the housing 100 and has a first operating position and a second operating position when in use, and the first sound hole 100a connects the external space of the protective shell 10 with the receiving cavity in the housing 100 at the first operating position, and the controller 16 disconnects the external space of the protective shell 10 from the receiving cavity in the housing 100 at the second operating position. The controller 16 can switch self state to change the communication state of the first sound hole 100a. For example, in a noisy environment or a high sound pressure environment, the controller 16 is started to allow sound to pass through the first sound hole 100a so that sound simultaneously enters the first sound hole 100a and the second sound hole 102a, and the microphone at the moment is equivalent to a unidirectional microphone; and in a relatively quite environment, the controller 16 is closed to prevent sound from passing through the first sound hole 100a and only allows the second sound hole 102a to be in a sound entry state, and the microphone at the moment is equivalent to an omnidirectional microphone. The controller 16 can be of a baffle structure disposed at the first sound hole 100a, the baffle can move or rotate relative to the first sound hole 100a, and the communication relation between the first sound hole 100a and the external space of the protective shell 10 can thus be cut off. Preferably, the controller 16 can be a sound pressure controller, in order to improve the performance of the microphone. The controller 16 can be disposed on the outer surface of the protective shell 10, i.e., the outer surface of the housing 100, thereby simplifying assembly and disassembly of the controller 16 and simultaneously facilitating the controller 16 to control the operating state of the microphone.

Preferably, the first sound hole 100a is smaller than the second sound hole 102a, so that the parameters of the two sound holes are different, and the unidirectional attribute of the microphone is thus strengthened, and the noise when the microphone operates is lower.

Further, the microphone 1 can further include a first damping mesh 18 covering the first sound hole 100a and/or a second damping mesh (not shown in the figure) covering the second sound hole. The first damping mesh 18 can be disposed on the inner wall or the outer wall of the housing 100 or embedded into the housing 100, and the second damping mesh can be disposed on the inner surface or the outer surface of the circuit board 102 or embedded into the circuit board 102. Taking the situation that the first damping mesh 18 covers the first sound hole 100a as an example, when the controller 16 controls the first sound hole 100a to be in a communicated state, the microphone at the moment is in a unidirectional state, and the first damping mesh 18 acts on the sound entering from the first sound hole 100a, wherein the first damping mesh 18 can strengthen the sound effect of the microphone; and when the controller 16 controls the first sound hole 100a to be in a disconnected state, sound cannot enter from the first sound hole 100a, and the first damping mesh 18 does not act. The first damping mesh 18 and the second damping mesh are not limited in size, as long as they cover the first sound hole 100a and the second sound hole 102a.

### Embodiment 2

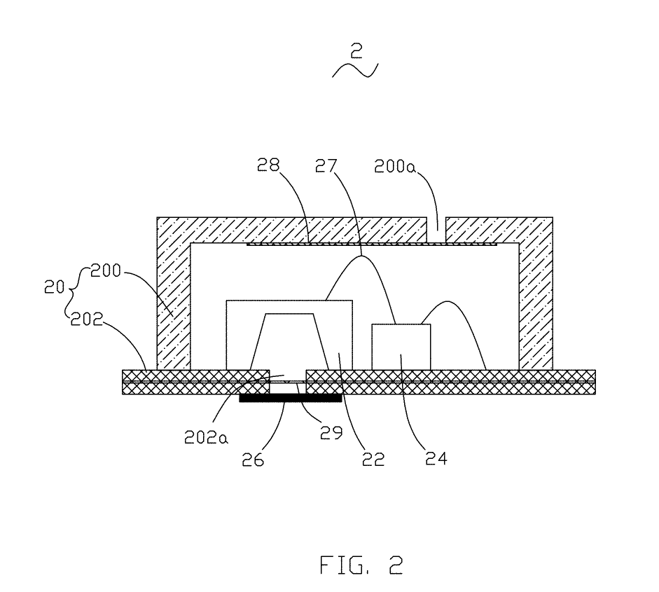

As shown in FIG. 2, a microphone 2 includes a protective shell 20, a micro electromechanical chip 22 with a back cavity, a control circuit chip 24, a controller 26 and a connecting wire 27.

The protective shell 20 includes a housing 200 and a circuit board 202 connected with the housing 200 by covering to form a receiving cavity. The micro electromechanical chip 22 and the control circuit chip 24 are received in the receiving cavity, and specifically, can be disposed on the circuit board 202 and electrically connected to the circuit board 202 by the connecting wire 27. The housing 200 is provided with a first sound hole 200a communicated with the receiving cavity in the housing 200, and the circuit board 202 is provided with a second sound hole 202a communicated with the back cavity of the micro electromechanical chip 22.

The controller 26 is disposed on the circuit board 202 and has a first operating position and a second operating position when in use, and the second sound hole 202a connects the external space of the protective shell 20 with the back cavity of the micro electromechanical chip 22 at the first operating position, and the controller 26 disconnects the external space of the protective shell 20 from the back cavity of the micro electromechanical chip 22 at the second operating position. The controller 26 can switch self state to change the communication state of the second sound hole 202a. For example, in a noisy environment or a high sound pressure environment, the controller 26 is started to allow sound to pass through the second sound hole 202a so that sound simultaneously enters the first sound hole 200a and the second sound hole 202a, and the microphone at the moment is equivalent to a unidirectional microphone; and in a relatively quite environment, the controller 26 is closed to prevent sound from passing through second sound hole 202a and only allows the first sound hole 200a to be in a sound entry state, and the microphone at the moment is equivalent to an omnidirectional microphone. The controller 26 can be of a baffle structure disposed at the second sound hole 202a, the baffle can move or rotate relative to the second sound hole 202a, and the communication relation between the second sound hole 202a and the external space of the protective shell 20 can thus be cut off. Preferably, the controller 26 can be a sound pressure controller, in order to improve the performance of the microphone. The controller 26 can be disposed on the outer surface of the circuit board 202, thereby simplifying assembly and disassembly of the controller 26 and simultaneously facilitating the controller 26 to control the operating state of the microphone.

Further, in order to strengthen the operating performance of the microphone in the unidirectional state, the microphone 2 can further include a first damping mesh 28 covering the first sound hole 200a and/or a second damping mesh 29 covering the second sound hole. The first damping mesh 28 can be disposed on the inner wall or the outer wall of the housing 200 or embedded into the housing 200, and the second damping mesh 29 can be disposed on the inner surface or the outer surface of the circuit board 202 or embedded into the circuit board 202. The first damping mesh 28 and the second damping mesh 29 are not limited in size, as long as they cover the first sound hole 200a and the second sound hole 202a.

It can be known according to the contents of embodiment 1 and embodiment 2 that two controllers can be provided and separately disposed at the first sound hole and the second sound hole, thereby realizing the operating state that sound enters from the top or the bottom or both the top and the bottom of the microphone. When the microphone is not used, the two controllers can control the first sound hole and the second sound hole to be closed simultaneously.

The present disclosure can provide another microphone, including a protective shell, a micro electromechanical chip, a control circuit chip and a controller.

The protective shell generally can include a housing and a circuit board which are fixedly connected with each other to form a receiving cavity, and the micro electromechanical chip and the control circuit chip can be disposed in the receiving cavity, and specifically, can be electrically connected to the circuit board. The protective shell is provided with a first sound hole and a second sound hole, and a first sound entry channel is formed in the first sound hole, and a second sound entry channel is formed in the second sound hole. The first sound hole is formed in the housing, and the second sound hole is formed in the circuit board.

The controller is disposed on the protective shell, and is used for controlling connection and disconnection of at least one of the first sound entry channel and the second sound entry channel. When the first sound entry channel is connected, external sound can enter the protective shell via the first sound entry channel; and when the first sound entry channel is disconnected, external sound cannot enter the first sound entry channel. Similarly, when the second sound entry channel is connected, external sound can enter the protective shell via the second sound entry channel; and when the second sound entry channel is disconnected, external sound cannot enter the second sound entry channel.

Specifically, the controller can adjust self state to realize connection and disconnection of the first sound entry channel or/and the second sound entry channel, and the microphone can be switched into a unidirectional microphone or an omnidirectional microphone under different conditions, so that one microphone in a device can realize the functions of two kinds of microphones, and the internal space and the manufacturing cost of the device are reduced; and the microphone can freely switch the operating mode according to different states, so that the sound quality is improved.

The microphone can further include a damping part disposed at the first sound hole, and the damping part can damp the first sound entry channel to strengthen the sound performance at the first sound entry channel. The microphone can further include a damping part disposed at the second sound hole, and the damping part can damp the second sound entry channel to strengthen the sound performance at the second sound entry channel.

Compared with the prior art, the microphone provided by the present invention is additionally provided with a controller and simultaneously provided with a first sound hole and a second sound hole, and the controller controls the sound entry state of the first sound hole or/and the second sound hole, and the microphone can be switched into a unidirectional microphone or an omnidirectional microphone under different conditions, so that one microphone in a device can realize the functions of two kinds of microphones, and the internal space and the manufacturing cost of the device are reduced; the microphone can freely switch the operating mode according to different states, so that the sound quality is improved; and the microphone can weaken the defects during operation, e.g., close talking effect produced by the unidirectional microphone, high noise of the omnidirectional microphone, etc.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A microphone, comprising a protective shell, wherein the protective shell includes a housing and a circuit board connected with the housing by covering to form a receiving cavity, and the housing is provided with a first sound hole communicated with the receiving cavity;
in the receiving cavity, the microphone further comprises a control circuit chip and a micro electromechanical chip with a back cavity which are disposed on the circuit board, and the circuit board is provided with a second sound hole communicated with the back cavity;
the microphone further comprises a controller disposed at the first sound hole;
the controller has a first operating position and a second operating position, and the first sound hole connects the external space of the protective shell with the receiving cavity at the first operating position, and the controller disconnects the external space of the protective shell from the receiving cavity at the second operating position.

2. The microphone as described in claim 1, further comprising a first damping mesh covering the first sound hole and/or a second damping mesh covering the second sound hole.

3. The microphone as described in claim 2, wherein the first damping mesh is disposed on the inner wall of the housing.

4. The microphone as described in claim 2, wherein the second damping mesh is embedded into the circuit board.

5. The microphone as described in claim 1, wherein the controller is disposed on the outer surface of the protective shell.

6. The microphone as described in claim 1, wherein the first sound hole is smaller than the second sound hole.

7. The microphone as described in claim 1, wherein the controller is a sound pressure controller.

8. A microphone, comprising a protective shell, wherein the protective shell includes a housing and a circuit board connected with the housing by covering to form a receiving cavity, and the housing is provided with a first sound hole communicated with the receiving cavity;
in the receiving cavity, the microphone further comprises a control circuit chip and a micro electromechanical chip with a back cavity which are disposed on the circuit board, and the circuit board is provided with a second sound hole communicated with the back cavity;
the microphone further comprises a controller disposed at the second sound hole;
the microphone further comprises a controller disposed at the second sound hole;
the controller has a first operating position and a second operating position, and the second sound hole connects the external space of the protective shell with the back cavity at the first operating position, and the controller disconnects the external space of the protective shell from the back cavity at the second operating position.

9. The microphone as described in claim 8, further comprising a first damping mesh covering the first sound hole and/or a second damping mesh covering the second sound hole.

10. The microphone as described in claim 9, wherein the first damping mesh is disposed on the inner wall of the housing.

11. The microphone as described in claim 9, wherein the second damping mesh is embedded into the circuit board.

12. The microphone as described in claim 8, wherein the controller is disposed on the outer surface of the circuit board.

13. The microphone as described in claim 8, wherein the first sound hole is smaller than the second sound hole.

14. The microphone as described in claim 8, wherein the controller is a sound pressure controller.

15. A microphone, comprising a protective shell and a controller, wherein the protective shell comprises a circuit board and a housing connected with the circuit board by covering to form a receiving cavity, the housing is provided with a first sound hole, the circuit board is provided with a second sound hole, a first sound entry channel is formed in the first sound hole, and a second sound entry channel is formed in the second sound hole; the controller is disposed on the housing or the circuit board, and is used for controlling connection and disconnection of the first sound entry channel or the second sound entry channel.

16. The microphone as described in claim 15, further comprising a damping part disposed at the first sound hole to damp the first sound entry channel.

17. The microphone as described in claim 15, further comprising a damping part disposed at the second sound hole to damp the second sound entry channel.
